(19) United States
(12) Patent Application Publication
(10) Pub. No.: US 2025/0271836 A1
(43) Pub. Date: Aug. 28, 2025

(54) SPOT ON CHEMICAL DISTRIBUTION POD FOR VEHICLE WASH FACILITIES

(71) Applicant: Claire Cunningham, Mission Hills, KS (US)

(72) Inventors: Claire Cunningham, Mission Hills, KS (US); Jason Cunningham, Mission Hills, KS (US)

(21) Appl. No.: 18/586,438

(22) Filed: Feb. 24, 2024

(51) Int. Cl. G05B 19/416

(52) U.S. Cl. CPC G05B 19/416; G05B 2219/37371

(57) ABSTRACT

A system for improving efficiency of resource use at wash facilities is provided. The system comprises a chemical pod installed at a wash facility that receives captured data describing a vehicle as the vehicle enters a wash facility for servicing. Based at least on the data, the system also receives a determination that elements of a cleaning system at the facility are not optimally configured for servicing of the vehicle. The system also alters flow of resources of the cleaning system based on instructions received based at least on the determination. Elements of the cleaning system comprise at least one applicator. The resources comprise at least one of chemicals, water, and air. The determination and the instructions are received from at least one control system. Adjustments to the resources are controlled electronically and without physical swapping of components or manual intervention.

### CROSS REFERENCE TO RELATED APPLICATIONS

None

### FIELD OF THE DISCLOSURE

The present disclosure is in the field of vehicle wash facility management. More particularly, the present disclosure provides systems and methods of a chemical distribution pod and cleaning systems for use in a wash facility that adjusts flow volume and dilution levels of chemicals, water, and air without the need for manual replacement or configuration of applicators or other wash facility hardware.

### BACKGROUND

Vehicle wash facilities use a great deal of chemicals, water, electricity and manpower, often at excessive levels without management awareness for days or longer at a time. In many cases, estimates are all management can rely on. Wash facility equipment is inexact in its use of materials and often requires visual observation and manual adjustment.

In modern car wash facilities, whether tunnel, in-bay automatic, or self-serve, detergents and other cleaning solutions used are designed to loosen and eliminate dirt and grime. The industry has made efforts to shift to safer cleaning solutions. Many wash facilities are required by law to treat and/or reuse their water and may be required to maintain wastewater discharge permits. This contrasts with unregulated facilities or even driveway washing at residences, for example, where wastewater can end up in storm drains and eventually in streams, rivers, lakes, and the ocean.

Mechanized car washes, especially those with brushes, may risk damaging the exterior finish of vehicles. Paint finishes have improved as have car washing processes. More facilities utilize “brushless” (cloth) and “touch-free” (high-pressure water) equipment, as well as modern “foam” washing wheels made of closed-cell foam.

The wash facility industry has made strides in reducing its environmental footprint, a trend that will continue to accelerate due to regulation and consumer demand. Many wash facilities use water reclamation systems to significantly reduce water usage and a variety of energy usage reduction technologies. These systems may be mandatory where water restrictions are in place.

### BRIEF DESCRIPTION OF THE FIGURES

FIG. 1a is a diagram of a chemical distribution pod according to an embodiment of the present disclosure.

FIG. 1b is a diagram of a chemical distribution pod according to an embodiment of the present disclosure.

FIG. 1c is a diagram of a chemical distribution pod according to an embodiment of the present disclosure.

FIG. 2a is a diagram of a chemical distribution pod according to an embodiment of the present disclosure.

FIG. 2b is a diagram of a chemical distribution pod according to an embodiment of the present disclosure.

FIG. 3 is an image of an applicator associated with a chemical distribution pod according to an embodiment of the present disclosure.

### DETAILED DESCRIPTION

Systems and methods described herein provide a chemical distribution pod device installed at a vehicle wash facility with numerous functions electronically controllable including real time control of flow of resources including chemicals, water, and air. Adjustments to resource flow are controlled electronically and without physical swapping or changing out of components or other manual intervention. Dilution rates of chemicals may be fine-tuned and need not be prescribed by or dependent upon physical limitations of components such as sizes of valves, metering tips, or other restrictive flow devices used in previous implementations. The system obviates or renders unnecessary the changing of metering tips to adjust application flow of chemical or other resources.

The system detects entry of each vehicle as it enters a tunnel area of a wash facility. The system calculates real-time vehicle length and uses actual live data when populating resource cost per vehicle in display devices provided by the system and used by wash facility personnel. Resource application may be adjusted to optimize the cleaning system on a per vehicle basis. The system supports electronic adjustment of water flow to allow unlimited flow rates unlike systems that utilize fixed water restriction devices.

Many functions of the chemical pod are at least partially controllable by the system which provides built-in feedback loops for assurance that functions are performing as intended. The system enables calculation of amounts of chemical ingredients used per vehicle serviced. A control system that regulates multiple chemical pods may be configured to automatically adapt resource flow based upon recent local weather conditions via a weather application plugin. The pod receives input from the control system to adapt resource application.

The chemical pod is a rack assembly, upright in form factor, that includes chemical tanks, inventory control, level sensors, usage monitoring, and chemical dosing pumps. Proportional water valves and electropneumatic air regulators are also key components.

The system allows the user to set data thresholds for each component that is handling resources. This allows alerts to be sent to specified users in the event an anomaly occurs.

The chemical pod also includes a chemical monitoring module that is associated with at least one applicator at the wash facility. The pod receives instructions about altering chemical volume and dilution rates at applicators via the chemical monitoring module. Chemical volume is measurable by at least one of milliliters per vehicle, milliliters per second, dilution rate, and cost per vehicle.

The chemical pod also comprises flow monitors and applicators that pull water in a single closed system of the pod. The pod, with the assistance of the control system, adjusts water flow based on input from redundant feedback sensors to ensure accuracy and optimization of the cleaning system. Data about the adjustments to water flow are sent back to the control system. The system does away with the need for personnel to manually adjust or physically replace fixed water restriction devices. The system further promotes adjustment of water flow to achieve desired dilution ratios for cleaning system optimization.

The chemical pod is a fail-safe system to ensure water is being applied correctly through all applicators by using a flow meter that provides feedback to the control system. Because multiple applicators are pulling water in the same closed system in series, the system will automatically adjust the water flow to achieve the desired gallons per minute (GPM) at each applicator.

The system further supports electronic adjustment of air flow via electropneumatic air regulator devices unlike systems that utilize manual air regulation devices. The system has air manifolds including air inputs. Similar to water flow, electronic adjustment of air flow may be based on directives from the control system. The system promotes optimal aeration of chemicals, for example soaps, to achieve desired foaming and presentation when the chemical is applied to the vehicle during washing. Achieving this without the chemical pod is a trial-and-error exercise that involves swapping of physical components.

The above actions involving chemical, water, air flow may be accomplished through a single panel in a cohesive unit. This is instead of having the air, water and chemical on separate panels where a change on one requires on site physical adjustment to the other two and so on.

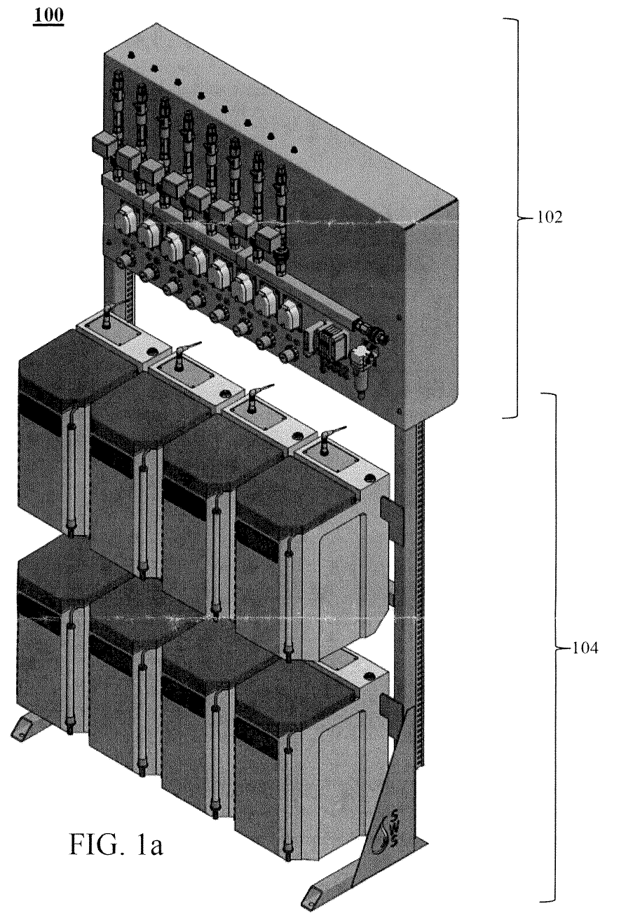

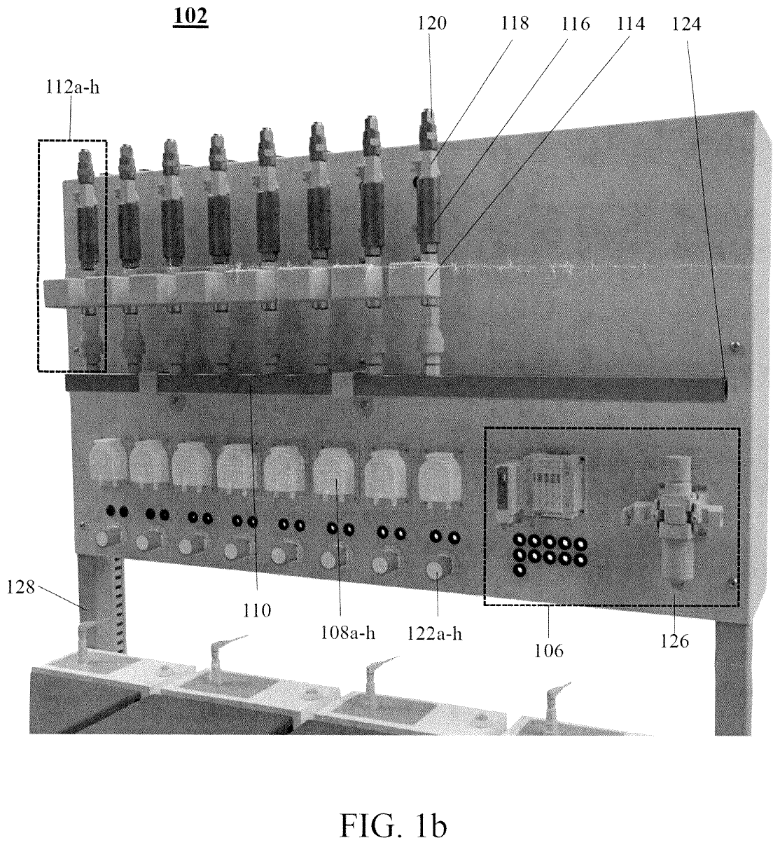

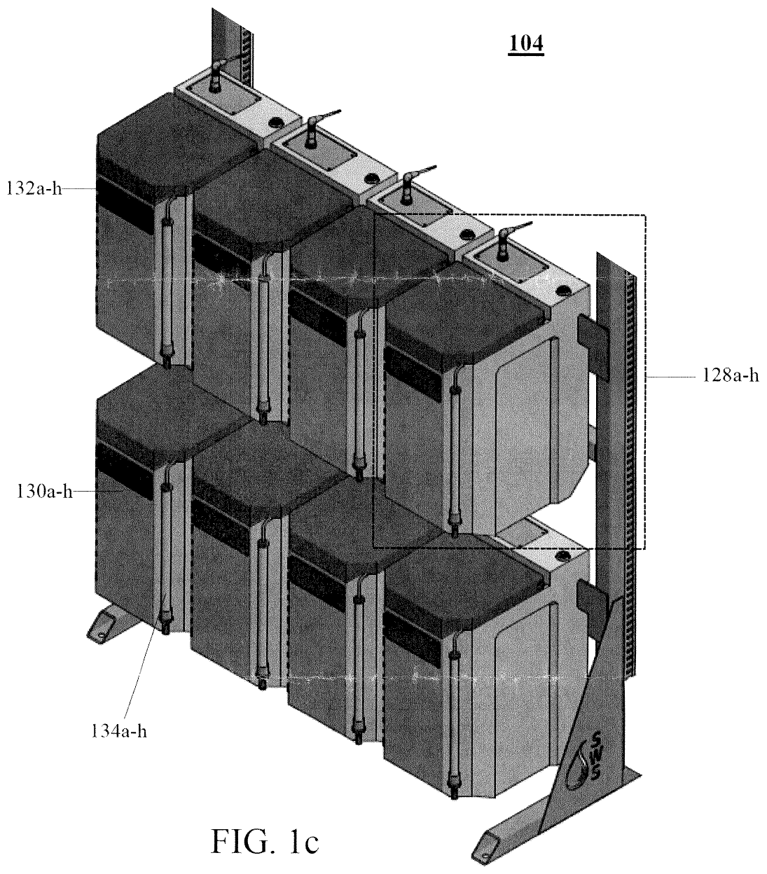

Turning to the figures, FIG. 1a is a diagram of a system of a chemical pod 100 with two component sections comprising a panel 102 and a tank assembly area 104 shown in FIG. 1b and FIG. 1c. As noted, the form factor of the system 100 is a rack structure with the panel 102 above the tank assembly area 104. A control system, which may comprise computers and mobile devices used by operators, is part of the overall systems provided herein but is not depicted.

FIG. 1b is a view of the panel 102 of system 100. The panel 102 comprises an air valve manifold 106, quantity eight (8) peristaltic chemical pumps 108a-h, a water manifold 110, and quantity eight (8) removable valve assemblies 112a-h. Each removable valve assembly 112a-h comprises a proportional valve 114, a flow meter 116, an injector 118, and an output valve 120.

The system 100 also comprises quantity eight (8) manual air regulators 122a-h, a water intake 124, and an air intake 126. An electropneumatic air regulator is installed at a backside of the panel 102 and is not visible in the figures. The electropneumatic air regulator controls air pressure and may replace the manual air regulators 122a-h. The electropneumatic air regulator is included if air pressure is being regulated by the pod. Air is regulated manually in the standard unit and via an electropneumatic air regulator for the pro model.

Also included but not shown in FIG. 1b is a programmable logic controller (PLC) that reads requests and opens valves for a desired gallons per minute of liquid flow. Flow sensors make readings and send feedback to the PLC.

FIG. 1c is a view of the tank assembly area 104 which comprises quantity eight (8) chemical tank assemblies 128a-h, each assembly 128a-h comprising a chemical tank 130a-h, a content label 132a-h, and a site glass for manual measurement 134a-h.

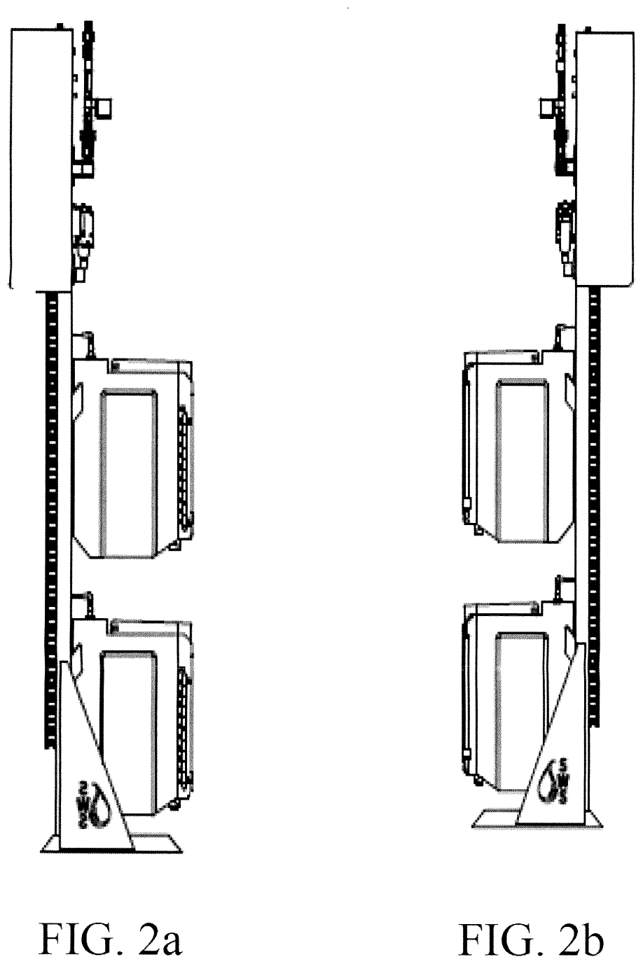

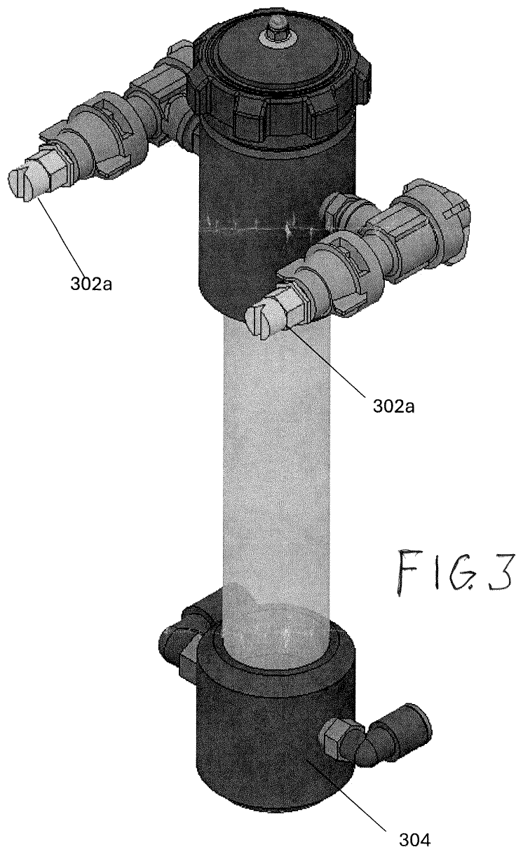

FIG. 2a is a side view of the chemical distribution pod from a left-side perspective. FIG. 2b is a side view of the pod from a right-side perspective.

FIG. 3 is an image of an applicator 300 that is used in a wash facility to spray mixtures of resources and other substances at vehicles as the vehicles pass through a wash facility. The applicator 300 comprises ingresses 302a and 302b wherein one the ingresses 302a-b are used for intake of chemicals, water, or air. The applicator 300 also comprises a nozzle through which the mixture of chemicals, water, and air are sprayed at vehicles as they pass through the wash facility.

In an embodiment, a system for improving efficiency of resource use at wash facilities is provided. The system comprises a chemical pod installed at a wash facility that receives captured data describing a vehicle as the vehicle enters a wash facility for servicing. Based at least on the data, the system also receives a determination that elements of a cleaning system at the facility are not optimally configured for servicing of the vehicle. The system also alters flow of resources of the cleaning system based on instructions received based at least on the determination.

Elements of the cleaning system comprise at least one applicator. The resources comprise at least one of chemicals, water, and air. The determination and the instructions are received from at least one control system. Adjustments to the resources are controlled electronically and without physical swapping of components or manual intervention.

The system obviates a need to change out metering tips to adjust application flow of chemical resources. The system supports electronic adjustment for water flow to allow unlimited flow rates, unlike systems that utilize fixed water restriction devices.

The system supports electronic adjustment of air flow via electropneumatic air regulation device(s), unlike systems that utilize manual air regulation devices. The system enables a plurality of dilution and flow rates for fluid resources.

Dilution and flow rates of fluids are not limited by sizes of dials, by metering tips, or by other restrictive flow devices. Each function at least partially controllable by the system has a built-in feedback loop for assurance that the function is performing as intended.

The system enables calculation of amount of chemical ingredients used per vehicle serviced. The pod receives signals from a control system and can be configured to automatically adapt resource flow based upon recent local weather conditions via a weather application plugin to software.

The control system can be configured to automatically adapt resource application based upon vehicle recognition and computer learning to optimize the cleaning system. The system promotes configuration of data thresholds for each component, the thresholds enabling a sending of alerts to specified users based on occurrence of certain events.

The pod comprises at least chemical tanks arranged in a vertical manner to conserve physical space in wash facility equipment rooms. Vehicle length is measured and averaged throughout a time period to establish realistic metrics.

In another embodiment, a method of managing chemical usage at a wash facility is provided. The method comprises a chemical pod system installed at a wash facility reporting activity associated with a chemical monitoring module, the module associated with at least a first applicator at the wash facility. The method also comprises the pod receiving an instruction regarding alteration to at least a first chemical volume and to a first dilution rate at the first applicator and the pod implementing the instruction. The method also comprises the pod, having implemented the instruction, reporting a result thereof, the result comprising at least one of an updated chemical volume and an updated dilution rate at the first applicator.

The method also comprises components associated with the pod actively measuring a length of each vehicle as each vehicle enters the facility and adjusting resource application to optimize the cleaning system on a per vehicle basis. Chemical volume is measurable by at least one of milliliters per vehicle, milliliters per second, dilution rate, and cost per vehicle.

The system automatically adapts resource flow based upon recent local weather conditions. The method also comprises the pod adapting resource application based upon input from a control system that uses computer learning, vehicle recognition, and object detection to optimize the cleaning system.

Vehicle length is measured and averaged throughout a time period to establish metrics for the dashboard. Components of the pod are configurable for data thresholds, the thresholds enabling a sending of alerts to specified users based on occurrence of certain events.

In another embodiment, a system for managing water flow at wash facility locations is provided. The system comprises a chemical pod installed at a wash facility comprising at least flow monitor(s) and applicator(s) pulling water in a single closed system of the pod that sends a message via the at least one flow monitor about flow of water through the applicator(s). The system also adjusts the water flow based upon input from redundant feedback sensors to ensure water dispensing accuracy and optimization of the cleaning system. The system also allows for electronic adjustment to the water flow and updates monitoring functionality with at least data describing the adjusted flow.

The system replaces fixed water flow restriction device(s). The system obviates a need to manually adjust or physically replace fixed water restriction devices at wash facility locations.

The system promotes alteration of water flow to achieve desired dilution ratios for cleaning system optimization. The system promotes configuration of data thresholds for each component, the thresholds enabling a sending of alerts to specified users based on occurrence of certain events.

In yet another embodiment, a system for managing air flow at wash facility locations is provided. The system comprises a chemical pod installed at a wash facility. The pod comprises at least an air manifold including air input(s) for each wash facility application online in a closed system of the pod and an electropneumatic air regulator for air line(s) controlled by the system that sends a message via the at least one electropneumatic air regulator about flow of air through the line(s). The system also allows for electronic adjustment of the air flow based upon received directives and updates display devices with at least data describing the adjusted air flow.

The system replaces fixed manual air regulation device(s). The system obviates a need to manually adjust or physically replace manual air regulation devices at wash facility locations.

The system promotes optimal aeration of chemical (i.e. soap) dispensed at the wash facility to achieve desired foaming and presentation when the chemical is applied to vehicles receiving servicing at the facility. The system promotes configuration of data thresholds for each component, the thresholds enabling a sending of alerts to specified users based on occurrence of certain events.

What is claimed is:

1. A system for improving efficiency of resource use at wash facilities, comprising:
a chemical pod installed at a wash facility that:
receives captured data describing a vehicle as the vehicle enters a wash facility for servicing,
based at least on the data, receives a determination that elements of a cleaning system at the facility are not optimally configured for servicing of the vehicle, and
alters flow of resources of the cleaning system based on instructions received based at least on the determination.

2. The system of claim 1, wherein elements of the cleaning system comprise at least one applicator.

3. The method of claim 1, wherein the resources comprise at least one of chemicals, water, and air.

4. The system of claim 1, wherein the determination and the instructions are received from at least one control system.

5. The system of claim 1, wherein adjustments to the resources are controlled electronically and without physical swapping of components or manual intervention.

6. The system of claim 1, wherein the system obviates a need to change out metering tips to adjust application flow of chemical resources.

7. The system of claim 1, wherein the system supports electronic adjustment for water flow to allow unlimited flow rates, unlike systems that utilize fixed water restriction devices.

8. The system of claim 1, wherein the system supports electronic adjustment of air flow via electropneumatic air regulation device(s), unlike systems that utilize manual air regulation devices.

9. The system of claim 1, wherein the system enables a plurality of dilution and flow rates for fluid resources.

10. The system of claim 1, wherein dilution and flow rates of fluids are not limited by sizes of dials, by metering tips, or by other restrictive flow devices.

11. The system of claim 1, wherein each function at least partially controllable by the system has a built-in feedback loop for assurance that the function is performing as intended.

12. The system of claim 1, wherein the system enables calculation of amount of chemical ingredients used per vehicle serviced.

13. The system of claim 1, wherein the pod receives signals from a control system and can be configured to automatically adapt resource flow based upon recent local weather conditions via a weather application plugin to software.

14. The system of claim 1, wherein the control system can be configured to automatically adapt resource application based upon vehicle recognition and computer learning to optimize the cleaning system.

15. The system of claim 1, wherein the system promotes configuration of data thresholds for each component, the thresholds enabling a sending of alerts to specified users based on occurrence of certain events.

16. The system of claim 1, wherein the pod comprises at least chemical tanks arranged in a vertical manner to conserve physical space in wash facility equipment rooms.

17. The method of claim 1, wherein vehicle length is measured and averaged throughout a time period to establish realistic metrics.

18. A method of managing chemical usage at a wash facility, comprising:
a chemical pod system installed at a wash facility reporting activity associated with a chemical monitoring module, the module associated with at least a first applicator at the wash facility;
the pod receiving an instruction regarding alteration to at least a first chemical volume and to a first dilution rate at the first applicator;
the pod implementing the instruction; and
the pod, having implemented the instruction, reporting a result thereof, the result comprising at least one of an updated chemical volume and an updated dilution rate at the first applicator.

19. The method of claim 18, further comprising components associated with the pod actively measuring a length of each vehicle as each vehicle enters the facility and adjusting resource application to optimize the cleaning system on a per vehicle basis.

20. The method of claim 18, wherein chemical volume is measurable by at least one of milliliters per vehicle, milliliters per second, dilution rate, and cost per vehicle.

21. The method of claim 18, wherein the system automatically adapts resource flow based upon recent local weather conditions.

22. The method of claim 18, further comprising the pod adapting resource application based upon input from a control system that uses computer learning, vehicle recognition, and object detection to optimize the cleaning system.

23. The method of claim 18, wherein vehicle length is measured and averaged throughout a time period to establish metrics for the dashboard.

24. The method of claim 18, wherein components of the pod are configurable for data thresholds, the thresholds enabling a sending of alerts to specified users based on occurrence of certain events.

25. A system for managing water flow at wash facility locations, comprising:
a chemical pod installed at a wash facility comprising at least flow monitor(s) and applicator(s) pulling water in a single closed system of the pod that:
sends a message via the at least one flow monitor about flow of water through the applicator(s),
adjusts the water flow based upon input from redundant feedback sensors to ensure water dispensing accuracy and optimization of the cleaning system,
allows for electronic adjustment to the water flow, and
updates monitoring functionality with at least data describing the adjusted flow.

26. The system of claim 25, wherein the system replaces fixed water flow restriction device(s).

27. The system of claim 25, wherein the system obviates a need to manually adjust or physically replace fixed water restriction devices at wash facility locations.

28. The system of claim 25, wherein the system promotes alteration of water flow to achieve desired dilution ratios for cleaning system optimization.

29. The system of claim 25, wherein the system promotes configuration of data thresholds for each component, the thresholds enabling a sending of alerts to specified users based on occurrence of certain events.

30. A system for managing air flow at wash facility locations, comprising:
a chemical pod installed at a wash facility, the pod comprising at least:
an air manifold including air input(s) for each wash facility application online in a closed system of the pod; and
an electropneumatic air regulator for air line(s) controlled by the system that:
sends a message via the at least one electropneumatic air regulator about flow of air through the line(s),
allows for electronic adjustment of the air flow based upon received directives, and
updates display devices with at least data describing the adjusted air flow.

31. The system of claim 30, wherein the system replaces fixed manual air regulation device(s).

32. The system of claim 30, wherein the system obviates a need to manually adjust or physically replace manual air regulation devices at wash facility locations.

33. The system of claim 30, wherein the system promotes optimal aeration of chemical (i.e. soap) dispensed at the wash facility to achieve desired foaming and presentation when the chemical is applied to vehicles receiving servicing at the facility.

34. The system of claim 30, wherein the system promotes configuration of data thresholds for each component, the thresholds enabling a sending of alerts to specified users based on occurrence of certain events.
